(19) United States
(12) Patent Application Publication
(10) Pub. No.: US 2026/0294706 A1
(43) Pub. Date: Oct. 1, 2026

(54) RECLINE ASSEMBLY FOR A CHAIR WITH A SEAT AND A MOVABLE BACK SUPPORT

(71) Applicant: 9302204 CANADA INC. DBA CHEELCARE, Richmond Hill (CA)

(72) Inventors: Dmitry PALTSEV, Keswick (CA); Yevgeny CHERNY, Richmond Hill (CA); Gennady LISNYAK, Ricmond Hill (CA); Dmitry MARUKH, Aurora (CA); Eduard SOMIN, Richmond Hill (CA)

(21) Appl. No.: 19/096,322

(22) Filed: Mar. 31, 2025

(51) Int. Cl. A61G 5/10; A61G 5/12

(52) U.S. Cl. CPC A61G 5/1067; A61G 5/125

(57) ABSTRACT

A recline assembly for a chair with a seat and a movable back support has at least one movement linkage that includes: a base, lower, intermediate and upper linkage members, and a guide member. The lower linkage member is pivotably connected to the base for rotation thereabout between first and second rotational positions (for the lower linkage member), while also being pivotably connected the intermediate linkage member. The guide member constrains the intermediate linkage member to move along a fixed path as the lower linkage member pivots between the first and second rotational positions (for the lower linkage member), and the upper linkage member is connected to the back support and can pivot about the intermediate linkage member, while being opposingly rotatably coupled to the lower linkage member, so that one end of the upper linkage member can pivot rearwardly and downwardly, while the other end moves forwardly.

### FIELD OF THE DISCLOSURE

The present disclosure relates generally to mechanisms for reclining chairs. In particular, the disclosure relates to a recline assembly for a chair with a seat and a movable back support.

### BACKGROUND OF THE DISCLOSURE

A common type of adjustable chair is a wheelchair. Wheelchairs (including motorized wheelchairs) may be used by disabled individuals in order to move around in comfort and relative ease. A back support is usually provided on the frame of the wheelchair to receive the trunk of the user.

It is known in the art to provide seat backs in the wheelchair environment that allow the user to be selectively positioned in upright and reclined positions. The adjustment of these components is made possible by what is referred to in the art as “recline”. The seat back rotates about a seat pivot axis relative to the seat base or seat to allow the user to assume a reclined or upright position, or any position in between. The user's legs and buttocks remain substantially stationary on the seat during the reclining action.

While the selective positioning of the seat back can facilitate improved user comfort, shear forces can also be imposed on the user's back as the seat back pivots relative to the seat. This occurs because the center of rotation of the user's trunk (approximately located at the user's hip joint) does not coincide with the axis of rotation of the back support. Shearing is a problem because it can cause decubitus ulcers (pressure sores) on the user's body and because it creates problems in maintaining the correct position of the postural supports (e.g., chest pads, headrests) and control devices (e.g., chin control systems) relative to the user. Thus, after repeated use, the user's back is adversely effected by the friction or shearing action between the user and the seat back during the recline operation.

While various shear-reducing mechanisms for wheelchairs are known in the art (such as U.S. Pat. Nos. 4,655,471, 5,297,021, 4,333,681, and 5,297,021) many of these existing shear-reducing mechanisms contain complicated assemblies under the seat frame, resulting in an overall floor-to-seat height greater than that of the original wheelchair, while also resulting in a heavier, bulkier wheelchair that requires more frequent maintenance. The greater seat height of these wheelchairs can restrict accessibility to tables, desks, and transportation.

There is a need for a recline assembly for use on a wheelchair that may provide a compact, reliable, and economical seat back assembly that reduces the friction or shear force that is transferred between the seat back and the user when reclining the seat back.

The background herein is included solely to explain the context of the disclosure. This is not to be taken as an admission that any of the material referred to was published, known, or part of the common general knowledge as of the priority date.

### SUMMARY OF THE DISCLOSURE

According to an aspect, there is provided a recline assembly for a chair with a seat and a movable back support, the recline assembly comprising at least one movement linkage that includes: a base that includes a base connector that is positioned to be supported by a frame of the chair, an intermediate linkage member, a lower linkage member having a first pivot connection point that is pivotably connected to the base for rotation thereabout between a first rotational position for the lower linkage member and a second rotational position for the lower linkage member and a second pivot connection point that is pivotally connected to the intermediate linkage member, wherein the second pivot connection point of the lower linkage member is driven forwardly during pivoting of the lower linkage member towards the second rotational position for the lower linkage member, a guide member that is connected between base and the intermediate linkage member, wherein the guide member is structured to constrain the intermediate linkage member to move along a fixed path as the lower linkage member pivots between the first and second rotational positions for the lower linkage member, and an upper linkage member that includes an upper linkage member connector positioned for connecting to the back support, wherein the upper linkage member includes a first pivot connection point and a second pivot connection point, wherein the first pivot connection point is pivotably connected to the intermediate linkage member, wherein the upper linkage member is pivotable relative to the intermediate linkage member between a first rotational position for the upper linkage member and a second rotational position for the upper linkage member, wherein the second pivot connection point of the upper linkage member is driven rearwardly and downwardly during pivoting of the upper linkage member towards the second rotational position for the upper linkage member, thereby driving the upper linkage member towards a horizontal orientation, wherein the lower linkage member is opposingly rotatably coupled to the upper linkage member such that pivoting of one of the lower linkage member and the upper linkage member towards the second rotational position for said one of the lower linkage member and the upper linkage member, drives pivoting of the other of the lower linkage member and the upper linkage member towards the second rotational position for said other of the lower linkage member and the upper linkage member, which drives the first pivot connection point of the upper linkage member forwardly, and drives the second pivot connection point of the upper linkage member downwardly and rearwardly.

In another aspect, an angle adjustment assembly for a chair, the chair include a first body portion support member and a second body portion support member. In the examples shown herein the first body portion support member is a seat and the second body portion support member is the back support. The angle adjustment assembly includes at least one movement linkage that includes the base, the lower linkage member, the intermediate linkage member, the upper linkage member, and a guide member, all of which may be modified in shape for the particular positional relationships applicable to the particular usage. For example, for a headrest application, the first body portion support member may be the back support of the chair and the second body portion support member may be a movable headrest. For a leg rest application the first body portion support member may be the back support of the chair and the second body portion support member may be a movable leg rest. The base includes a base connector that is positioned to be supported by a frame of the chair. The lower linkage member has a first pivot connection point that is pivotably connected to the base for rotation thereabout between a first rotational position for the lower linkage member and a second rotational position for the lower linkage member and a second pivot connection point that is pivotally connected to the intermediate linkage member, wherein the second pivot connection point of the lower linkage member is driven forwardly during pivoting of the lower linkage member towards the second rotational position for the lower linkage member. The guide member is connected between the base and the intermediate linkage member, and is structured to constrain the intermediate linkage member to move along a fixed path as the lower linkage member pivots between the first and second rotational positions for the lower linkage member. The upper linkage member includes an upper linkage member connector positioned for connecting to the second body portion support member, and includes a first pivot connection point and a second pivot connection point. The first pivot connection point is pivotably connected to the intermediate linkage member. The upper linkage member is pivotable relative to the intermediate linkage member between a first rotational position for the upper linkage member and a second rotational position for the upper linkage member. The second pivot connection point of the upper linkage member is driven rearwardly and downwardly/upwardly (e.g. for a back support or a headrest), or forwardly and upwardly/downwardly (e.g. for a leg rest, an armrest or a footrest) during pivoting of the upper linkage member towards the second rotational position for the upper linkage member, thereby driving the upper linkage member towards a horizontal orientation, wherein the lower linkage member is opposingly rotatably coupled to the upper linkage member such that pivoting of one of the lower linkage member and the upper linkage member towards the second rotational position for said one of the lower linkage member and the upper linkage member, drives pivoting of the other of the lower linkage member and the upper linkage member towards the second rotational position for said other of the lower linkage member and the upper linkage member, which drives the first pivot connection point of the upper linkage member forwardly or rearwardly to reduce shear on the body of the user, and drives the second pivot connection point of the upper linkage member downwardly and rearwardly. For the rearward and downward movement of the second pivot connection point of the upper linkage member, the first pivot connection point is driven forward. For the rearward and upward movement of the second pivot connection point of the upper linkage member, the first pivot connection point is driven rearward. For the forward and downward movement of the second pivot connection point of the upper linkage member, the first pivot connection point is driven rearward. For the forward and upward movement of the second pivot connection point of the upper linkage member, the first pivot connection point is driven forward.

### BRIEF DESCRIPTION OF THE DRAWINGS

Embodiments will now be described, by way of example only, with reference to the attached Figures, wherein:

FIG. 1 shows a perspective view of a motorized wheelchair that includes the recline assembly according to an embodiment of the present disclosure;

FIG. 2A shows a perspective view of the recline assembly according to an embodiment of the present disclosure, where the upper linkage member is in a first rotational position for the upper linkage member and the lower linkage member is in a first rotational position for the lower linkage member;

FIG. 2B shows a perspective view of the embodiment of the recline assembly in FIG. 2A, where the upper linkage member is in a second rotational position for the upper linkage member and the lower linkage member is in a second rotational position for the lower linkage member;

FIG. 3A shows a schematic diagram of the trunk of a user (U) seated on a reclining chair with the back support in an upright position;

FIG. 3B shows a schematic diagram of the trunk of a user (U) seated on a reclining chair with the back support in a reclined position;

FIG. 3C shows a schematic diagram of the trunk of a user (U) seated on a reclining chair with the back support supported on the embodiment of the recline assembly of FIG. 2A and the back support in an upright position;

FIG. 3D shows a schematic diagram of the trunk of a user (U) seated on a reclining chair with the back support supported on the embodiment of the recline assembly of FIG. 2A and the back support in a reclined position;

FIG. 4A shows another perspective view of the embodiment of the recline assembly in FIG. 2A, where the where the upper linkage member is in a first rotational position for the upper linkage member and the lower linkage member is in a first rotational position for the lower linkage member;

FIG. 4B shows a close-up, perspective view of the embodiment of the recline assembly in FIG. 4A;

FIG. 4C shows a close-up, perspective view of the embodiment of the recline assembly in FIG. 4A with one of the mount brackets of the mount body hidden from view;

FIG. 5A shows a perspective view of the upper linkage member of the embodiment of the recline assembly in FIG. 4A;

FIG. 5B shows a perspective view of the of the lower linkage member and guide member of the embodiment of the recline assembly in FIG. 4A;

FIG. 6 shows a perspective view of a first cross member of the embodiment of the recline assembly in FIG. 4A;

FIG. 7A shows a side view of the embodiment of the recline assembly in FIG. 2A, where the upper linkage member is in a first rotational position for the upper linkage member and the lower linkage member is in a first rotational position for the lower linkage member;

FIG. 7B shows a side view of the embodiment of the recline assembly in FIG. 2A, where the upper linkage member is in a first rotational position for the upper linkage member and the lower linkage member is in a first rotational position for the lower linkage member and one of the mount brackets of the mount body hidden from view;

FIG. 7C shows a side view of the embodiment of the recline assembly in FIG. 2A, where the upper linkage member is in a second rotational position for the upper linkage member and the lower linkage member is in a second rotational position for the lower linkage member;

FIG. 8A shows a close-up, side view of the embodiment of the recline assembly in FIG. 2A, where the upper linkage member is in a first rotational position for the upper linkage member and the lower linkage member is in a first rotational position for the lower linkage member;

FIG. 8B shows a close-up, side view of the embodiment of the recline assembly in FIG. 2A, where the upper linkage member is in a first rotational position for the upper linkage member and the lower linkage member is in a first rotational position for the lower linkage member, and where the first rotational positions for the lower linkage member and upper linkage member are indicated by dotted lines;

FIG. 8C shows a close-up, side view of the embodiment of the recline assembly in FIG. 2A, where the upper linkage member is in a second rotational position for the upper linkage member and the lower linkage member is in a second rotational position for the lower linkage member, and where the second rotational positions for the lower linkage member and upper linkage member are indicated by dotted lines and the first rotational positions for the lower linkage member and upper linkage member are indicated by faded dotted lines;

FIG. 8D shows another perspective view of the embodiment of the recline assembly in FIG. 2A, where the where the upper linkage member is in a first rotational position for the upper linkage member and the lower linkage member is in a first rotational position for the lower linkage member;

FIG. 9A shows a perspective view of the embodiment of the recline assembly in FIG. 2A, where the recline assembly includes an armrest and an armrest linkage;

FIG. 9B shows another perspective view of the embodiment of the recline assembly in FIG. 2A, where the recline assembly includes an armrest and an armrest linkage;

FIG. 10A shows a side view of an embodiment of the recline assembly with an alternative configuration of the movement linkage, where the upper linkage member is in a first rotational position for the upper linkage member and the lower linkage member is in a first rotational position for the lower linkage member;

FIG. 10B shows a side view of the embodiment of the recline assembly in FIG. 10A, where the upper linkage member is in a second rotational position for the upper linkage member and the lower linkage member is in a second rotational position for the lower linkage member;

FIG. 10C shows a front view of the embodiment of the recline assembly in FIG. 10A, where the upper linkage member is in a first rotational position for the upper linkage member and the lower linkage member is in a first rotational position for the lower linkage member;

FIG. 10D shows a close-up, side view of the movement linkage of the embodiment of the recline assembly in FIG. 10A, where the upper linkage member is in a first rotational position for the upper linkage member and the lower linkage member is in a first rotational position for the lower linkage member; and

FIG. 10E shows a close-up, side view of the movement linkage of the embodiment of the recline assembly in FIG. 10A, where the upper linkage member is in a second rotational position for the upper linkage member and the lower linkage member is in a second rotational position for the lower linkage member.

### DETAILED DESCRIPTION OF THE EMBODIMENTS

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures, and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one.”

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps, or components.

As used herein, the terms “about” and “approximately” are meant to cover variations that may exist in the upper and lower limits of the ranges of values, such as variations in properties, parameters, and dimensions.

As used herein, the terms “recline,” or “reclining” refer to a change in the angle of the back support of the chair relative to the seat. In this case, the angle of the back support relative to the seat increases or decreases to the desired position while the seat position relative to the rest of the chair stays constant.

As used herein, the terms “shear” or “shearing” refer to the tangential forces that occur as a result of the relative displacement between the user's trunk and the back support. As noted above, these tangential forces may develop because a center of rotation of the user's trunk (approximately located at the user's hip joint) does not coincide with an axis of rotation of the back support about the seat.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

The embodiments described herein are exemplary (e.g., in terms of materials, shapes, dimensions, and constructional details) and do not limit by the claims appended hereto and any amendments made thereto. Persons skilled in the art will appreciate that there are yet more alternative implementations and modifications possible, and that the following examples are only illustrations of one or more implementations. The scope of the disclosure, therefore, is only to be limited by the claims appended hereto and any amendments made thereto.

The recline assembly 10 as disclosed herein may provide a compact structure for varying center of rotation of a movable back support 6 (i.e., varying position of upper linkage member 20 (frame) as it rotates about intermediate linkage member 18) such that a magnitude of shear force that is applied to the body of a user by the back support 6 may be reduced.

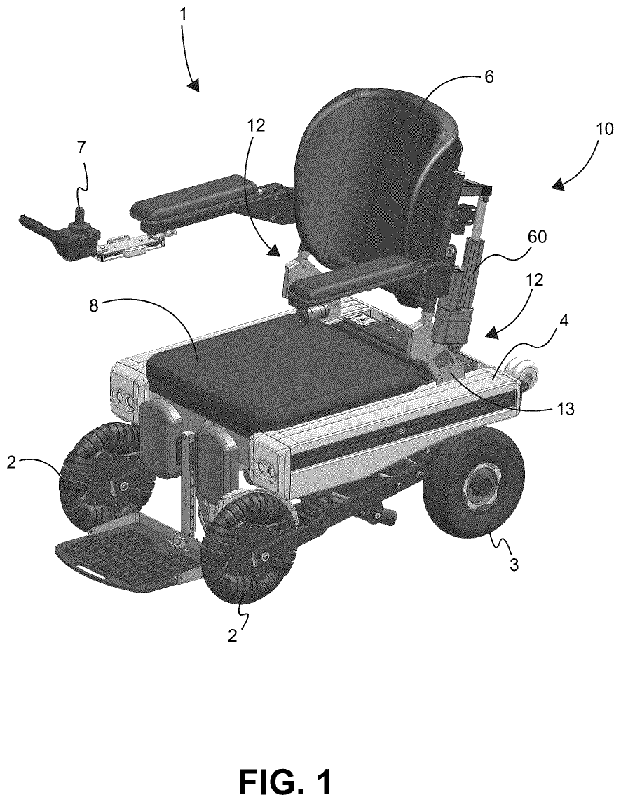

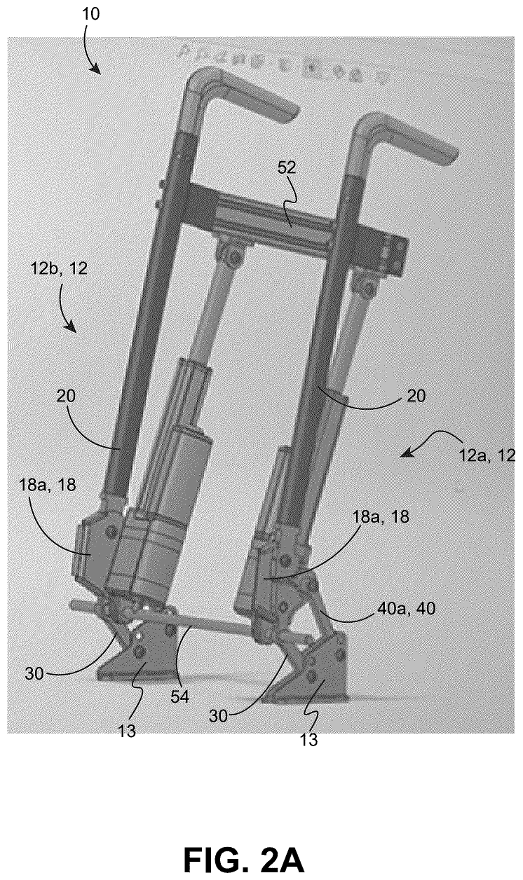

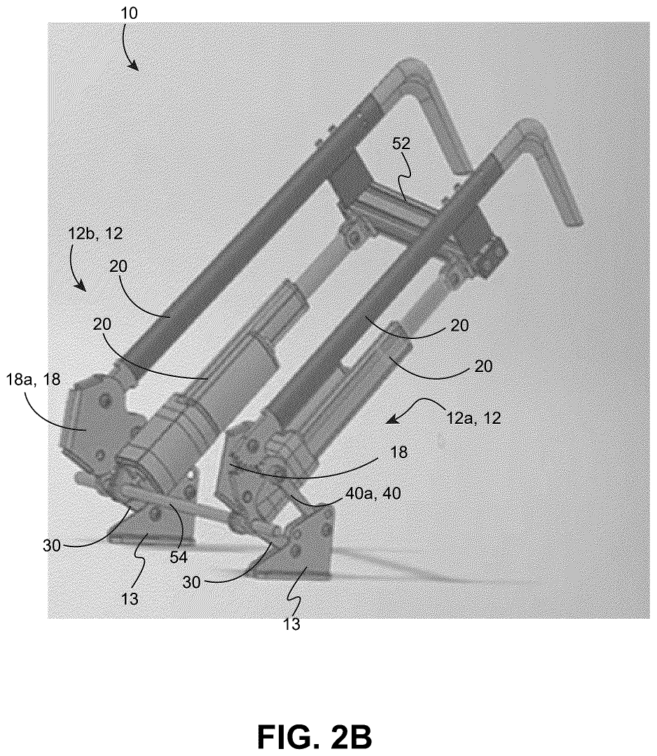

Referring to FIGS. 2A, 2B, and 4A to 8D, there is provided a first embodiment of the recline assembly 10 of the present disclosure. The recline assembly 10 is generally structured for use with a chair with a seat and a movable back support (such as the wheelchair 1 shown in FIG. 1). As shown in the Figures, the recline assembly 10 has at least one movement linkage 12. The at least one movement linkage 12 includes a base 13 having a base connector that is positioned to be supported by a frame of the chair. The at least one movement linkage 12 also includes an intermediate linkage member 18, a lower linkage member 30, a guide member 40, and an upper linkage member 20.

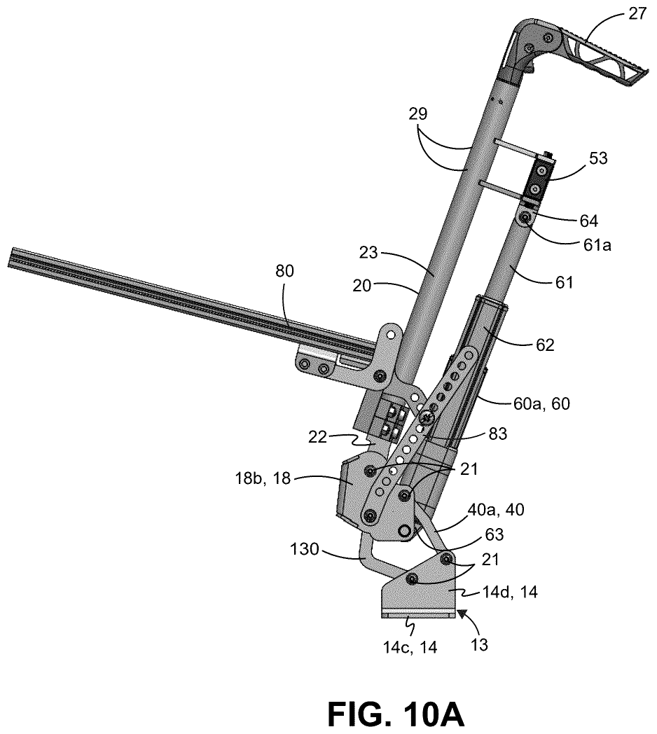

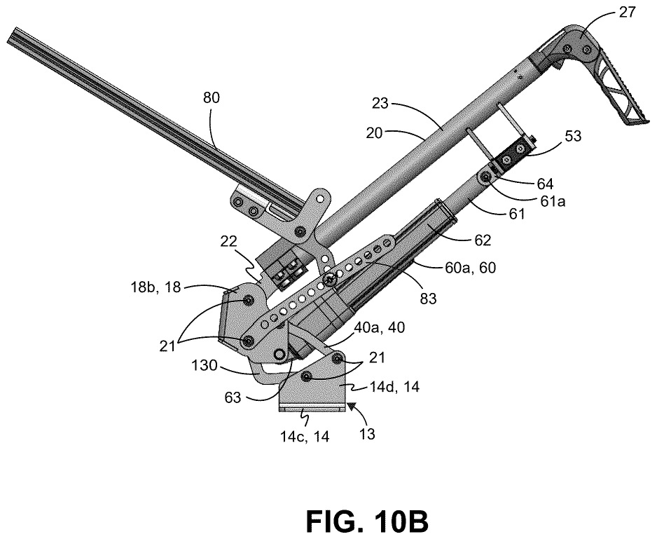

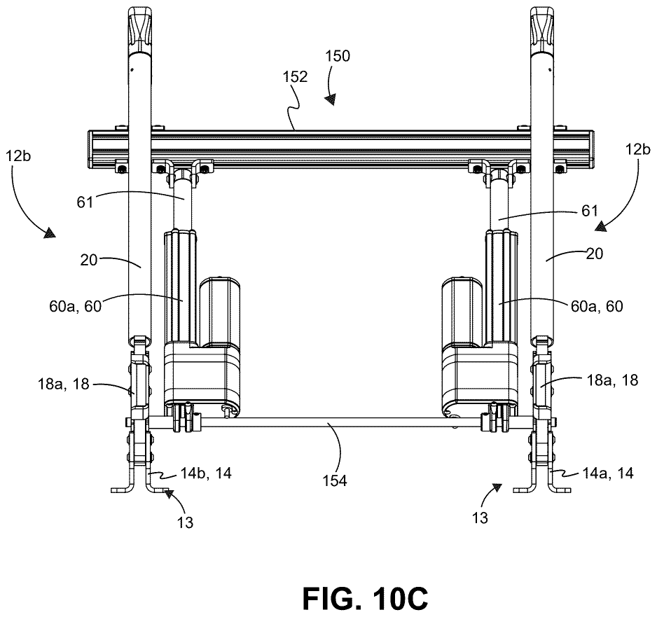

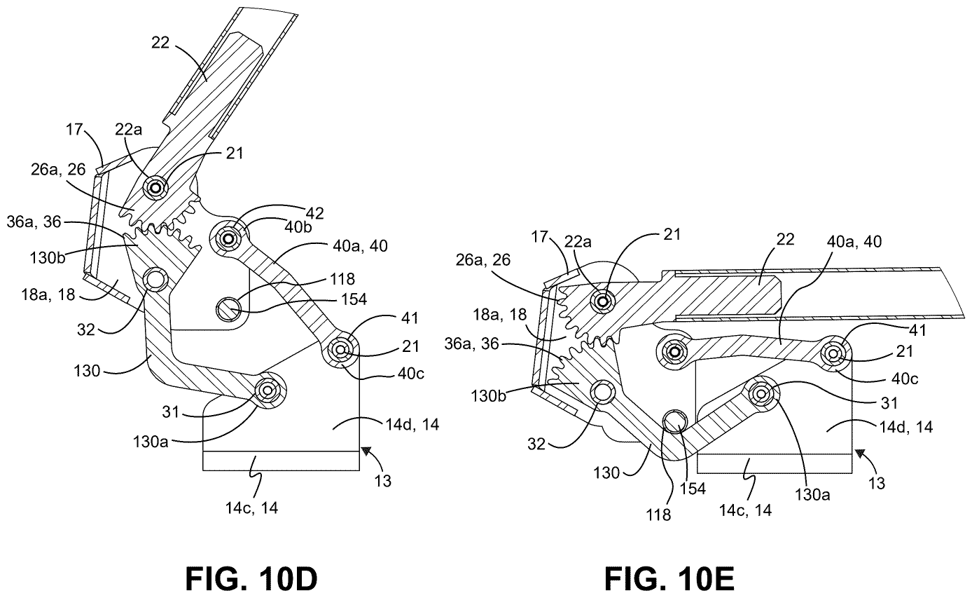

FIGS. 2A to 9D provide a first embodiment of the movement linkage 12 where the lower linkage member 30 is directly connected to an actuator 60, while FIGS. 10A to 10E provide an alternative embodiment of the movement linkage 12 where the lower linkage member 30 is not directly connected to the actuator 60, and the actuator 60 is instead connected directly to the intermediate linkage member 18.

As illustrated in FIGS. 2A, 2B, and 4A to 9D, the lower linkage member 30 has a first pivot connection point that is pivotably connected to the base 13 for rotation thereabout between a first rotational position for the lower linkage member 30 (shown in FIG. 2A) and a second rotational position for the lower linkage member 30 (shown in FIG. 2B). The lower linkage member 30 also has a second pivot connection point that is pivotally connected to the intermediate linkage member 18. As shown in FIGS. 2A and 2B, the second pivot connection point of the lower linkage member 30 is driven forwardly during pivoting of the lower linkage member 30 towards the second rotational position for the lower linkage member 30. The guide member 40 of the at least one movement linkage 12 is connected between base 13 and the intermediate linkage member 18. The guide member 40 is structured to constrain the intermediate linkage member 18 to move along a fixed path as the lower linkage member 30 pivots between the first and second rotational positions for the lower linkage member 30.

The upper linkage member 20 of the at least one movement linkage 12 includes an upper linkage member connector that is positioned for connecting to the back support 6. The upper linkage member 20 also includes a first pivot connection point and a second pivot connection point. The first pivot connection point is pivotably connected to the intermediate linkage member 18, where the upper linkage member 20 is pivotable relative to the intermediate linkage member 18 between a first rotational position for the upper linkage member 20 (shown in FIGS. 2A and 10A), and a second rotational position for the upper linkage member 20 (shown in FIGS. 2B and 10B). The movement of the upper linkage member 20 between the first and second rotational positions (for the upper linkage member 20) is such that the second pivot connection point of the upper linkage member 20 is driven rearwardly and downwardly during pivoting of the upper linkage member 20 towards the second rotational position for the upper linkage member 20. The rearward and downward pivoting of the second pivot connection point on the upper linkage member 20 drives the upper linkage member 20 towards a horizontal orientation.

In the arrangement of the at least one movement linkage 12, the lower linkage member 30 is opposingly rotatably coupled to the upper linkage member 20 such that pivoting of one of the lower linkage member 30 and the upper linkage member 20 towards the second rotational position for said one of the lower linkage member 30 and the upper linkage member 20, drives pivoting of the other of the lower linkage member 30 and the upper linkage member 20 towards the second rotational position for said other of the lower linkage member 30 and the upper linkage member 20. This in turn drives the first pivot connection point of the upper linkage member 20 forwardly and drives the second pivot connection point of the upper linkage member 20 downwardly and rearwardly.

In additional embodiments of the at least one movement linkage 12, the first pivot connection point of the lower linkage member 30 is formed on a first end portion 30a of the lower linkage member 30, and the second pivot connection point of the lower linkage member 30 is formed on a second end portion 30b of the lower linkage member that is opposite the first end portion 30a. Similarly, the first pivot connection point of the upper linkage member 20 is formed on a first end portion of the upper linkage member 20, and the second pivot connection point of the upper linkage member 20 is formed on a second end portion of the upper linkage member 20 that is opposite the first end portion 30a.

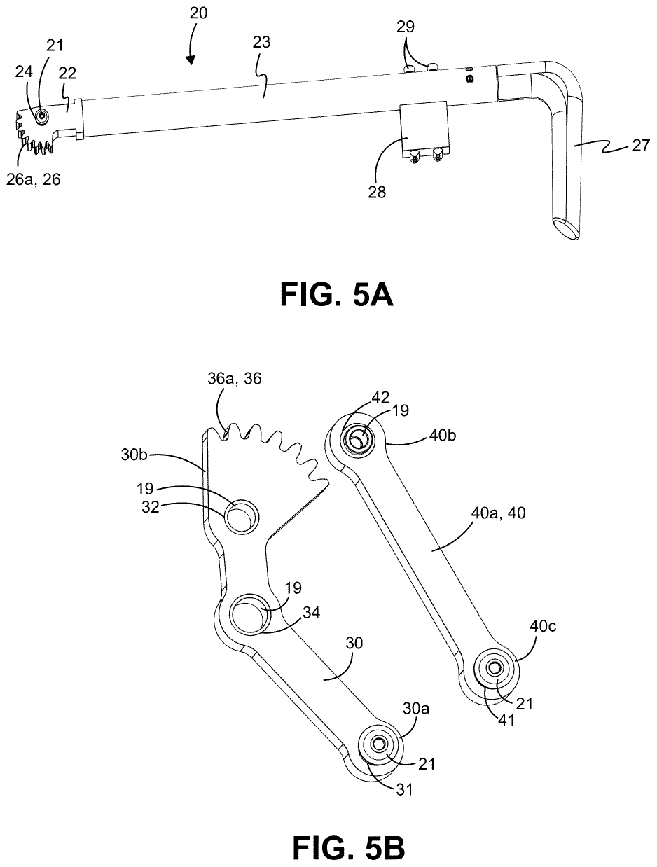

Various configurations of the upper linkage member 20, lower linkage member 30, guide member 40, and intermediate linkage member 18 may be provided as part of the recline assembly 10 disclosed herein. In an embodiment such as provided in FIGS. 5A and 5B, the upper linkage member 20 includes at least a first upper mounting aperture 24 formed on the first end portion thereof. The opposing first and second end portions 30a, 30b of the lower linkage member 30 include first and second lower mounting apertures 31, 32, and opposing ends of the guide member 40 include first and second guide mounting apertures 41, 42 to facilitate connection between the lower linkage member 30, upper linkage member 20, guide member 30 and other components of the at least one movement linkage 12. The first upper mounting aperture 24 may define the first pivot connection point for the upper linkage member 20, while the first and second lower mounting apertures 31, 32 may define the respective first and second pivot connection points for the lower linkage member 30.

In an additional embodiment such as shown in FIGS. 5A and 5B, a bushing 19 may be provided in at least some of the mounting apertures (i.e., mounting apertures 24, 31, 32, 41, 42) on the upper linkage member 20, lower linkage member 30, and guide member 40 of the movement linkages 12. The bushings 19 within the mounting apertures may facilitate a secure connection of the upper, lower and guide members 20, 30, 40 about pin connections that are received in the mounting apertures, and smooth pivoting of the upper, lower and/or guide members 20, 30, 40 about these pin connections.

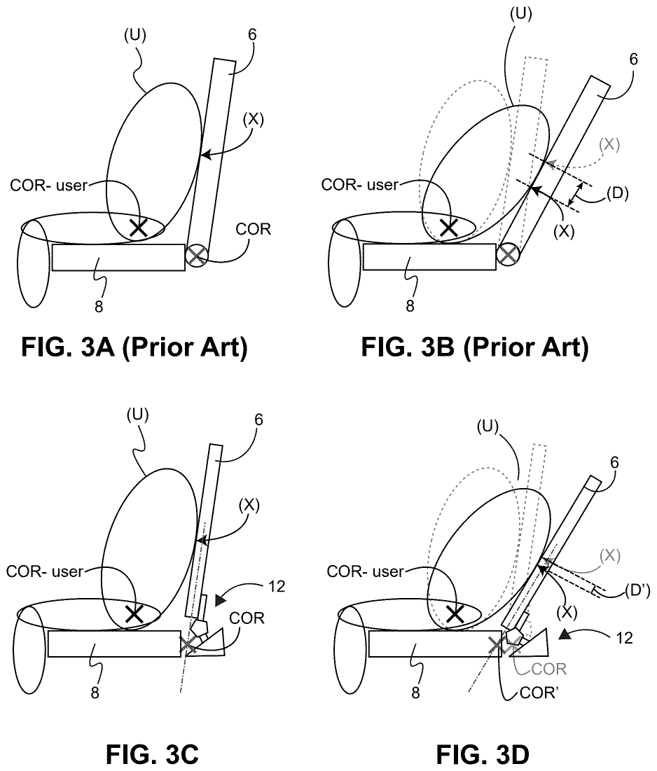

In the operation of the recline assembly 10, the driving of the first pivot connection point of the upper linkage member 20 forward, and the driving of the second pivot connection point of the upper linkage member 20 downwardly and rearwardly will cause a virtual COR of the back support 6 (connected to the upper linkage member 20) to change position as the back support 6 reclines. Due to the movement of the upper linkage member 20, the virtual COR of the back support 6 will effectively shift forward and down. By providing a recline assembly 10 that produces a change in position of the virtual COR of the back support 6 so that the virtual COR moves forward and down, the points of contact for the body of a user (U) on the back support 6 may stay relatively more constant during reclining of the back support 6, and a magnitude of shear force that is applied to the body of a user (U) by the back support 6 during reclining may be reduced. Further specifics as to how the magnitude of shear force exerted by the back support 6 may be reduced will now be described with reference to FIGS. 3A to 3D.

In FIGS. 3A-3D, parts of the user's body are represented as simple ellipses, including a torso (the ellipse resting against the back support 6), the upper legs (the ellipse resting on the seat 8), and the lower legs (the ellipse extending downward from an end of the ellipse representing the upper legs). In conventional back supports (such as shown in FIGS. 3A and 3B), the back support pivots about a fixed COR when moving between the more upright position (FIG. 3A) and the more reclined position (FIG. 3B). Because the back support has a fixed COR, a main point of contact (X) of the user's back on the back support will change as the back support 6 moves from the upright position to the reclined position. The main point of contact (X) effectively slides a distance (D) down the back support as the back support moves from the upright position (shown in FIG. 3A) to the reclined position (shown in FIG. 3B). This distance (D) is related to the change in angle of the back support when moving from the upright to the reclined position. The sliding of the main point of contact (X) along the distance (D) generates the aforementioned shearing force on the user's back.

By structuring the recline assembly 10 to reposition the virtual COR of the back support 6 forward and downward as the back support 6 reclines, the effective sliding distance (D′) of the main point of contact (X) along the back support 6 can be reduced. By providing the upper linkage member 20 where the first pivot connection point of the upper linkage member 20 moves forward and drives the second pivot connection point of the upper linkage member 20 downwardly and rearwardly during reclining, and the virtual COR of the back support is translated forward and down (shown in FIGS. 3C and 3D). With this movement of the virtual COR, the back support 6 is effectively translated forwards and down while the back support 6 reclines. The forward and downward translation of the back support 6, together with the reclining motion, effectively reduces the distance (D′) that the main point of contact (X) slides along the back support 6, thereby reducing the shear force that is experienced by the user (U) from the back support 6.

The recline assembly 10 as disclosed herein is suitable for use with various types of chairs that include a seat, a movable back support and a frame that supports the seat.

In an embodiment such as provided in FIG. 1, the chair is a motorized wheelchair 1 that includes the seat and the back support 6 supported on a wheelchair frame. A wheelchair typically includes a frame having wheels where the frame supports the seat assembly. The seat assembly may typically include the seat 8 and the back support 6, as shown in FIG. 1.

In the specific embodiment provided in FIG. 1, the wheelchair 1 includes a frame 4 to which is mounted a pair of small diameter front wheels 2 and a pair of larger diameter rear wheels 3. The frame 4 is preferably of a sturdy, rigid construction such as with aluminum members having a rectangular cross section that support caster mountings for the front wheels 2, and a drive assembly associated with the rear wheels 3. A seat on the frame 4 of the wheelchair 1 includes the seat 8 and the back support 6. Each of the seat 8 and back support 6 may include underlying support structures which support the seat 8 and the back support 6, respectively, to which upholstery, cushions, or other seating systems may be secured. Thus, the seat is secured to the frame 4 of the wheelchair 1.

In the same embodiment provided in FIG. 1, the wheelchair 1 is a motorized wheelchair 1a. The illustrated motorized wheelchair 1a also includes on-board batteries (not shown) that supply power to drive motors associated with the respective rear wheels 3. A processing system is provided and is connected to motors that drive the wheels, a steering mechanism, and the like. The processing system generally controls overall operation of all powered aspects of the motorized wheelchair 1. The user controls operation of the wheelchair 1 through a control interface, such as the joystick assembly 7, that is mounted on an armrest. As is conventional in the art, movement of the joystick of the joystick assembly controls the operation of the motors for driving the rear wheels 3, and the front wheels 2 rotate about their respective vertical axes in response to the driving force imposed by the rear wheels 3. The motorized wheelchair 1a as described above is of well-known structure, at least in parts.

As shown in FIG. 1, the recline assembly 10 of the present disclosure is mounted on a top surface of the frame 4 of the motorized wheelchair 1, rearward of the seat 8. The recline assembly 10 is sized such that the back support 6 of the motorized wheelchair 1a is position above, and to the rear of the seat 8, at a height that would be comfortable for a user of the motorized wheelchair 1. The recline assembly 10 is provided for reclining the back support 6 of the motorized wheelchair 1.

In an embodiment such as provided in FIGS. 2A, 2B, 4A to 4C, 6 and 8A to 10E, the at least one movement linkage 12 includes the actuator 60 that is operatively connected to at least one of i) the lower linkage member 30, ii) the upper linkage member 20, and iii) the intermediate linkage member 18. The actuator 60 is operatively connected to the lower linkage member 30, the intermediate linkage member 18 and/or the upper linkage member 20 to drive pivoting of the lower linkage member 30 and/or the upper linkage member 20 towards the second rotational position for the lower linkage member 30 and/or the upper linkage member 20.

The actuator 60 as provided as part of the at least one movement linkage 12 may be various types of actuators as are known in the art.

In an embodiment, the actuator 60 is a rotary actuator (such as a rotary drive unit) that is operatively connected to the lower linkage member 30, the intermediate linkage member 18, and/or the upper linkage member 20. Generally, the rotary actuator drives the lower linkage member 30 and/or the upper linkage member 20 to rotate between the respective first and second rotational positions for the lower linkage member 30 and/or the upper linkage member 20. The rotary actuator can be connected to the movement linkage 12 in various specific ways. For example, the rotary actuator can include an actuator housing and a drive shaft, where the actuator housing is mounted to the base 13 of the movement linkage 12, and the drive shaft is rotatably coupled to the first pivot connection point of the lower linkage member 30 such that the rotary actuator is operable to rotate the lower linkage member 30 between the first and second positions for the lower linkage member 30 and to thereby drive the movement of the rest of the movement linkage 12.

In an alternative embodiment such as shown in FIGS. 2A, 2B, 4A to 4C, and 6 to 10E, the actuator 60 is a linear actuator 60a. The present disclosure provides for various arrangements of this linear actuator 60a on the movement linkages 12.

In an embodiment shown in FIGS. 2A, 2B, 4A to 4C, and 6 to 9B, the linear actuator 60a has a first end that is pivotally connected to the upper linkage member 20 and a second end that is pivotally connected to the lower linkage member 30. In this same embodiment, the at least one movement linkage 12 of the recline assembly 10 includes two movement linkages 12 (i.e., the at least one movement linkage includes a first movement linkage 12a and a second movement linkage 12b).

In the specific embodiment provided in FIGS. 1 to 2B, 4A to 4C, 6 and 8A to 8D, each movement linkage 12 includes an associated linear actuator 60a that is connected thereto such that the recline assembly 10 also includes a pair of linear actuators 60a. The first and second movement linkages 12a, 12b are laterally spaced apart from one another so as to define a gap therebetween. The bases 13 of the first and second movement linkages 12a, 12b are longitudinally aligned with one another and laterally spaced apart.

In an alternative embodiment shown in FIGS. 10A to 10E, the linear actuator 60a has a first end that is pivotally connected to the upper linkage member 20 and a second end that is pivotally connected to the intermediate linkage member 18 of the movement linkage 12. In the specific embodiment provided in FIGS. 10A to 10E, each movement linkage 12 includes an associated linear actuator 60a that is connected thereto such that the recline assembly 10 also includes a pair of linear actuators 60a. The first and second movement linkages 12a, 12b are laterally spaced apart from one another so as to define a gap therebetween. The bases 13 of the first and second movement linkages 12a, 12b are longitudinally aligned with one another and laterally spaced apart.

In an additional embodiment such as is provided in FIGS. 2A to 2B, 4A to 4C, and 6 to 10E, the recline assembly 10 further comprises a plurality of cross members 50 that are connected between the first and second movement linkages 12a and 12b of the recline assembly 10 for bracing the first and second movement linkages 12a and 12b and forming a frame therewith.

In an embodiment such as provided in FIGS. 2A to 2B, 4A to 4C, and 6 to 9B, the plurality of cross members 50 includes a first cross member 52 and a second cross member 54. The first cross member 52 extends laterally and is connected between the upper linkage member 20 of the first movement linkage 12a and the upper linkage member 20 of the second movement linkage 12b. The second cross member 54 of the recline assembly 10 is connected between the lower linkage member 30 of the first movement linkage 12a and the lower linkage member 30 of the second movement linkage 12b.

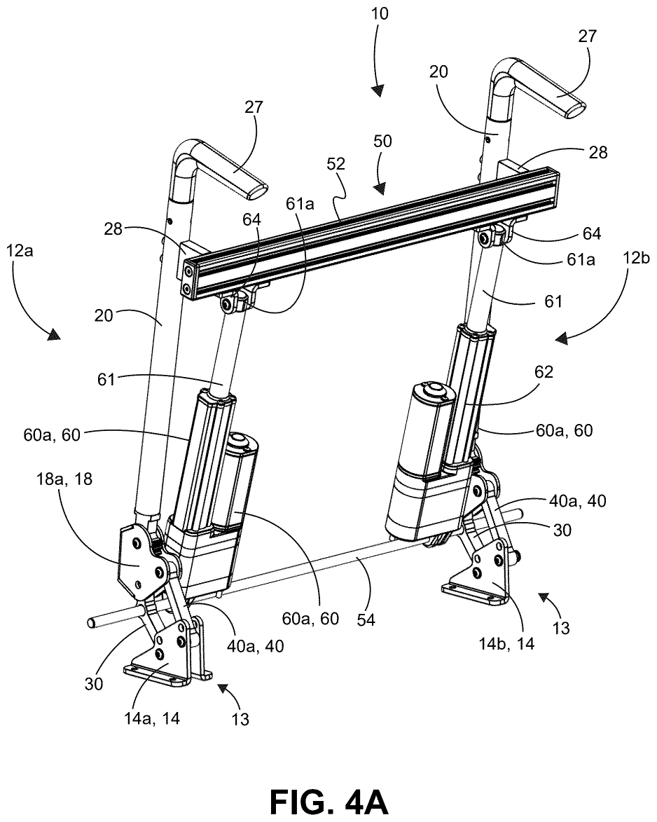

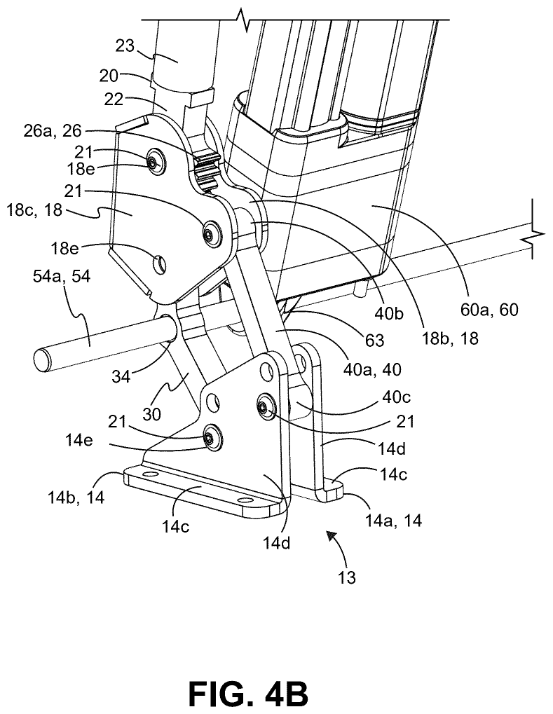

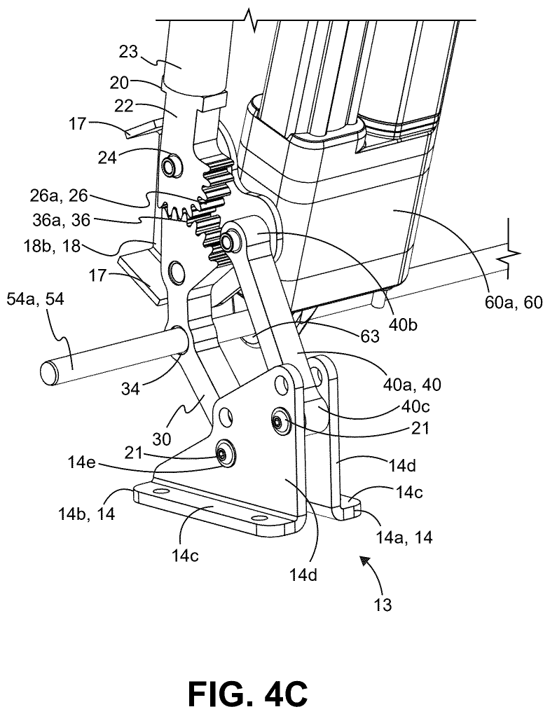

In the specific embodiment provided in FIGS. 4A to 4C, the first cross member 52 supports one end of the actuators 60 of the two movement linkages 12 (e.g. the free ends 61a of the actuator rods 61 of the two movement linkages 12) thereby connecting the one end of the actuators 60 to the upper linkage members 20 of the two movement linkages 12. The second cross member 54 is mounted through an intermediate portion of the lower linkage member 30 each of the first and second movement linkages 12a, 12b.

In an alternative embodiment such as provided in FIGS. 10A to 10E, the recline assembly 10 further comprises a plurality of cross members 150 which includes a first cross member 152 and a second cross member 154. The first cross member 152 extends laterally and is connected between the upper linkage member 20 of the first movement linkage 12a and the upper linkage member 20 of the second movement linkage 12b. The second cross member 154 of the recline assembly 10 is connected between the intermediate linkage members 18 of the first and second movement linkages 12a, 12b.

In the specific embodiment provided in FIGS. 10A to 10E, the first cross member 152 supports one end of the actuators 60 of the two movement linkages 12 (e.g. the free ends 61a of the actuator rods 61 of the two movement linkages 12) thereby connecting the one end of the actuators 60 to the upper linkage members 20 of the two movement linkages 12. The second cross member 154 is mounted through a cross member aperture 118 in the intermediate linkage member 18 (e.g., the mount body 18a) of each of the first and second movement linkages 12a, 12b.

The back support 6 of the chair may be connected to the recline assembly 10 in various ways. In at least some embodiments, the back support 6 of the chair is connected to the upper linkage members 20 of the first and second movement linkages 12a, 12b, while in at least some other embodiments, the back support 6 of the chair is connected to a part of the plurality of cross members 50 that is connected between the upper linkage members 20 (i.e., the first cross member 52). The back support 6 of the chair reclines with the movement of the upper linkage member 20 from the first rotational position of the upper linkage member to the second rotational position of the upper linkage member 20. In the specific embodiment provided in FIG. 1, the back support 6 of the chair is directly connected to the first cross member 52 of the plurality of cross members 50.

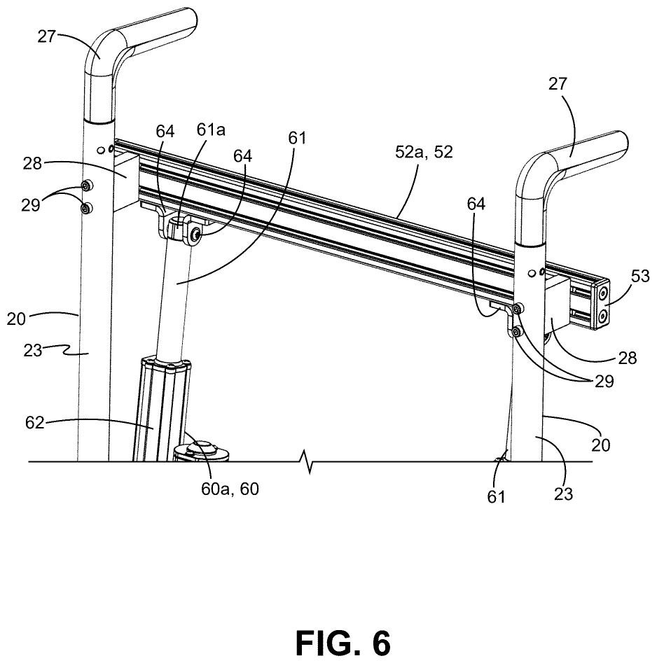

Additional embodiments of the plurality of cross members 50 and details regarding the connection of the plurality of cross members 50 to the first and second movement linkages 12a, 12b is provided later in the present disclosure with reference to FIGS. 4A, 4B, 4C and 6, as well as FIGS. 10A to 10E.

As provided above, the at least one movement linkage 12 of the recline assembly 10 includes the base 13 to which the first pivot connection point of the lower linkage member 30 is pivotably connected. Various structures and configurations of the base 13 are provided for in the present disclosure. For example, in the embodiment provided in FIGS. 4A, 4B, and 4C, the base 13 includes a support bracket 14 to which at least the lower linkage member 30 and the guide member 40 are pivotably connected.

In the specific embodiment provided in FIGS. 4A, 4B, and 4C, the support bracket 14 of the base 13 includes an inner bracket 14a and an outer bracket 14b, where the inner bracket 14a and the outer bracket 14b are arranged substantially parallel to one another, and to the upper and lower linkage members 20, 30. The inner bracket 14a and the outer bracket 14b are spaced apart to define a gap therebetween. Each of the inner bracket 14a and the outer bracket 14b includes a vertical flange 14d and a horizontal flange 14c that extends out from a bottom end of the vertical flange 14d. The horizontal flange 14c can be secured to the frame of the chair at various positions along the frame. In the exemplary embodiment shown in the Figures, the horizontal flange 14c of each bracket 14 is secured to the frame at a position that is rearward of the seat 8 of the wheelchair 1. The vertical flange 14d for each of the inner bracket 14a and the outer bracket 14b includes a plurality of mounting apertures 14e that extend through the vertical flange 14d. A plurality of pin connections 21 are provided in the gap between the inner and outer brackets 14a, 14b, and the plurality of pin connections are held in corresponding mounting apertures 14e on the vertical flanges 14d of each of the inner and outer brackets 14a, 14b.

As shown in FIG. 5B, a first end portion 30a of the lower linkage member 30 includes the first lower mounting aperture 31. The first lower mounting aperture 31 defines the first pivot connection point of the lower linkage member 30. As shown in FIGS. 4A to 4C, the first lower mounting aperture 31 of the lower linkage member 30 is pivotably received on one of the pin connections 21 between the inner bracket 14a and the outer bracket 14b for pivotably connecting the lower linkage member 30 to the bracket 14 of the base 13. The second end portion 30b of the lower linkage member 30 includes the second lower mounting aperture 32 and is pivotably connected to the intermediate linkage member 18 via a suitable pin connection 21.

As provided above, the at least one movement linkage 12 of the recline assembly also includes the guide member 40, where the guide member 40 is structured to constrain the motion of the intermediate linkage member 18, relative to the base 13, as the lower linkage member 30 pivots between the first and second rotational positions for the lower linkage member 30. As shown in FIGS. 4A to 4C, the guide member 40 is pivotably connected between a third point on the intermediate linkage member 18 (details of the intermediate linkage member 18 are provided below) and the base 13 of the at least one movement linkage 12 for supporting intermediate linkage member 18 as the lower linkage member 30 rotates between the first and second rotational positions for the lower linkage member 30.

In the specific embodiment provided in FIGS. 2A to 2B, and 4A to 10E, the guide member 40 includes a guide linkage 40a, and the guide linkage 40a is pivotably connected between the intermediate linkage member 18 (which is formed as a mount body 18a) and the base 13 so as to form a four-bar mechanism that includes the guide linkage 40a, upper linkage member 20, intermediate linkage member 18, and lower linkage member 30 (or the lower linkage member 130). Similarly to the lower linkage member 30 (or the lower linkage member 130), a first end portion 40c of the guide linkage 40a includes the first guide mounting aperture 41, and the first guide mounting aperture 41 is pivotably received over another one of the pin connections 21 between the inner bracket flange 14a and the outer bracket flange 14b of the support bracket 14 (i.e., a different pin connection than the pin connection 21 that receives the first lower mounting aperture 31 of the lower linkage member 30/lower linkage member 130) for pivotably connecting the guide linkage 40a to the base 13. A second end 40b of the guide member 40 opposite the first end 40c includes the second guide mounting aperture 42 and is pivotably connected to the intermediate linkage member 18 via a suitable pin connection 21.

In the various embodiments of the guide member 40 that include the guide linkage 40a, the guide linkage 40a may be structured such that the orientation of intermediate linkage member 18 stays constant during movement of lower linkage member 30/lower linkage member 130 between the first and second rotational positions for the lower linkage member, or the guide linkage 40a may be structured such that the orientation of the intermediate linkage member 18 varies during this motion of the lower linkage member 30/lower linkage member 130. For example, the length of guide linkage 40a and the length of the lower linkage member 30/lower linkage member 130 can be correspondingly selected such that the intermediate linkage member 18 is constrained to move at a fixed orientation as the lower linkage member 30 moves between the first and second rotational positions for the lower linkage member 30 (or for the lower linkage member 130).

While the above-described embodiment of the at least one movement linkage 12 is specific to the guide member 40 including the guide linkage 40a that is pivotably connected between the base 13 and the intermediate linkage member 18, other types of guide members 40 may alternatively be included as part of the movement linkages 12 of the recline assembly 10. For example, the guide member 40 may instead include a guide pin that is connected to the base 13, where this guide pin is received in a guide slot formed on the intermediate linkage member 18. The guide pin could be held in the guide slot such that as the lower linkage member 30 moves between the first and second rotational positions for the lower linkage member 30, the guide pin of the guide member 40 moves along the slot in the intermediate linkage member 18 so as to constrain the motion of the intermediate linkage member 18.

As provided above, the at least one movement linkage 12 includes the intermediate linkage member 18 to which the upper linkage member 20, lower linkage member 30, and guide member 40 are all connected. The intermediate linkage member 18 provides a structure about which one or more members (including the upper linkage member 20, lower linkage member 30 and/or guide member 40) may be connected (e.g., pivotably connected) to facilitate the rotation of the upper linkage member 20 between the first and second rotational positions for the upper linkage member 20, while the lower linkage member 30 rotates between the first and second rotational positions for the lower linkage member 30.

In the specific embodiment provided in FIGS. 2A to 2B, and 4A to 10E, the intermediate linkage member 18 includes the mount body 18a. The mount body 18a similarly provides a structure about which the one or more members may rotate to facilitate the rotation of the upper linkage member 20 between the first and second rotational positions for the upper linkage member 20 while the lower linkage member 30 (or the lower linkage member 130) rotates between the first and second rotational positions for the lower linkage member 30/lower linkage member 130. In this way, the mount body 18a acts as an intermediate “base” that can rotate relative to the base 13 of the at least one movement linkage 12, while the upper linkage member 20 rotates thereabout. Providing this intermediate base may facilitate the forward movement of the first pivot connection point of the upper linkage member 20 as the second pivot connection point of the upper linkage member 20 moves rearwardly and downwardly.

In an embodiment such as provided in FIGS. 4B to 4C, and 8A to 10E, the mount body 18a includes a hollow interior that houses at least a first end portion of the upper linkage member 20, the second end portion 30b of the lower linkage member 30 (or the second end portion 130b of the lower linkage member 130), and the second end portion 30b of the guide member 40.

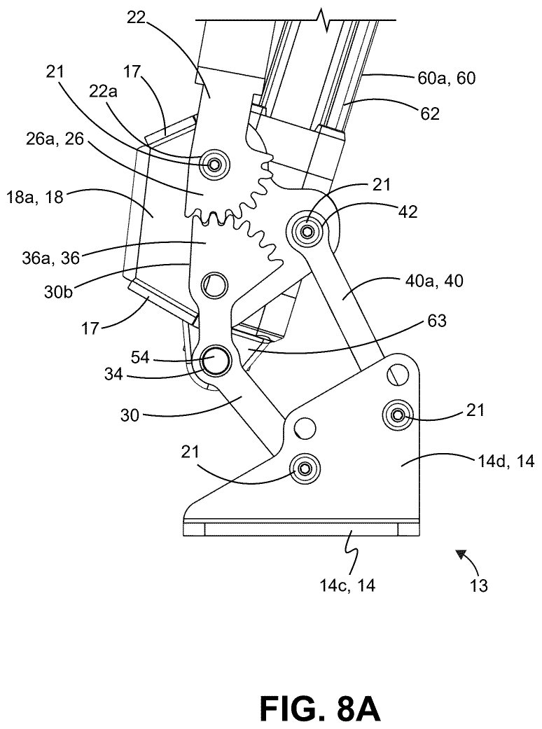

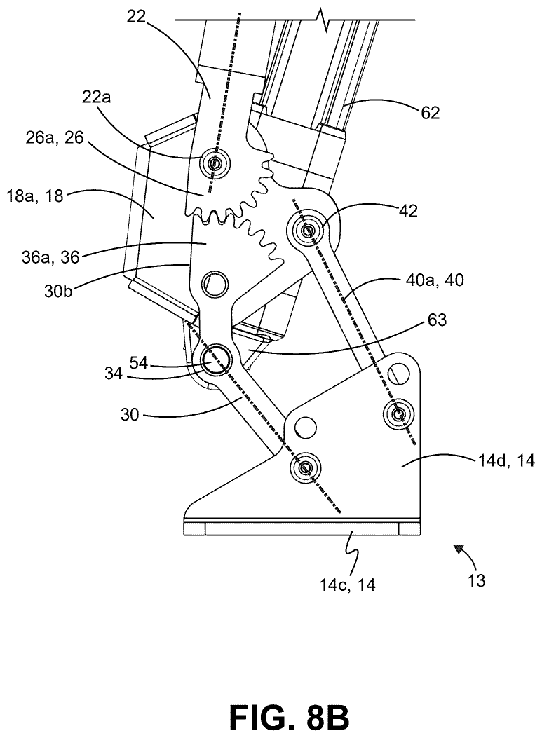

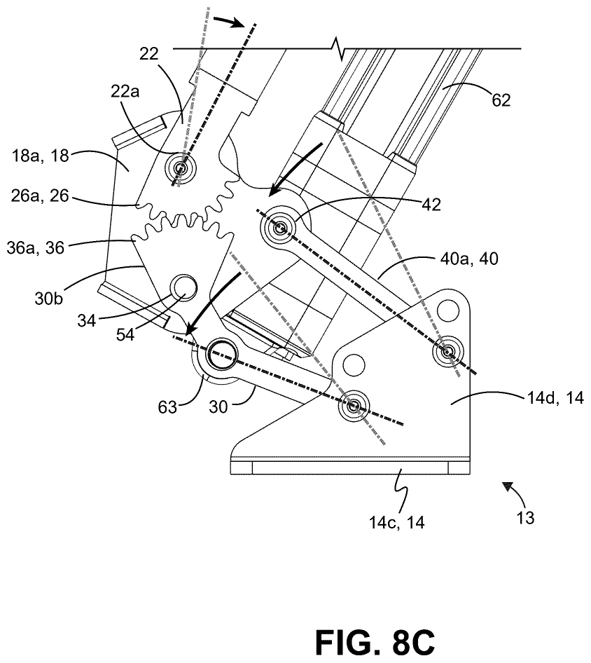

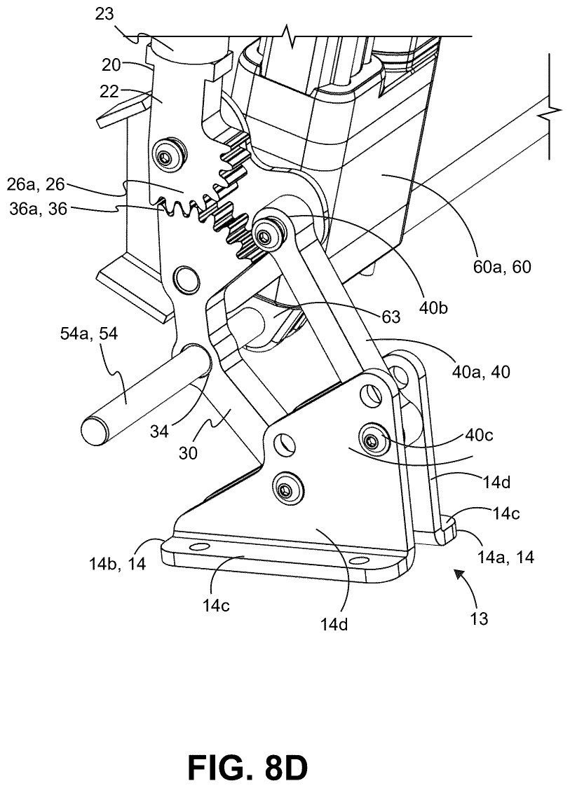

In the specific embodiment provided in FIGS. 4B to 4C, and 8A to 8D, the mount body 18a includes an inner mount bracket 18b and an outer mount bracket 18c. The inner and outer mount brackets 18b, 18c are connected to one another such that a gap is defined therebetween, where this gap effectively forms a hollow interior of the mount body 18a. Each of the inner mount bracket 18b and the outer mount bracket 18c includes a plurality of mount aperture 18e, and a plurality of pin connections 21 that are received between corresponding mount aperture 18e in the inner mount bracket 18b and the outer mount bracket 18c. A pair of corresponding mount aperture 18e in the inner mount bracket 18b and outer mount bracket 18c define a first point on the mount body 18, while other pairs of corresponding mounting apertures in the inner and outer mount brackets 18b, 18c define second and third points on the mount body 18. The second lower mounting aperture 33 of the lower linkage member 30 is pivotably received on one of the pin connections 21 between the inner mount bracket 18b and the outer mount bracket 18c. Similarly, the first upper mounting aperture 22a is pivotably received on another one of the pin connections 21 between the inner and outer brackets 18b, 18c, and the second guide mounting aperture 42 of the guide member 40 is pivotably received on yet another a pin connection 21 between the inner mount bracket 18b and outer mount bracket 18c.

The first end of the upper linkage member 20 and the second end portions 30b, 40b of the lower linkage member 30 and guide member 40 are contained between the inner and outer mount brackets 18b, 18c, within the hollow interior of the mount body 18. The hollow interior of the mount body 18a is sized to provide sufficient clearance in order to permit the rotation of the upper linkage member 20, lower linkage member 30 and guide member 40 therewithin.

As shown in FIGS. 4B to 4C, each of the inner and outer mount brackets 18b, 18c includes a flat base piece, and a plurality of bent flanges 17 that are spaced apart around a circumferential edge of the flat base piece. The plurality of bent flanges 17 are formed on the inner and outer mount brackets 18b, 18c such that when the inner and outer mount brackets 18b, 18c are connected (via the pin connections 21) the plurality of bent flanges 17 of the inner mount bracket 18b are disposed in the spaces between the plurality of bent flanges 17 on the outer mount bracket 18c, and vice versa. The plurality of bent flanges 17 on the inner and outer mount brackets 18b, 18c provided a barrier when inner and outer mount brackets 18b, 18c are secured to one other. This barrier may protect the components of the movement linkage 12 that are contained within the hollow interior of the mount body 18.

In embodiments, the mount body 18a is structured such that the hollow interior of the mount body 18a provides sufficient clearance to allow for rotational coupling of the lower linkage member 30 and upper linkage member 20, where this rotational coupling can be achieved by various suitable structures. As noted above, the lower linkage member 30 is opposingly rotatably coupled to the upper linkage member 20 such that pivoting of one of the lower linkage member 30 and the upper linkage member 20 towards the second rotational position for said one of the lower linkage member 30 and the upper linkage member 20 drives pivoting of the other of the lower linkage member 30 and the upper linkage member 20 towards the second rotational position for said other of the lower linkage member 30 and the upper linkage member 20, which in turn drives the first pivot connection point of the upper linkage member 20 forwardly, and drives the second pivot connection point of the upper linkage member 20 downwardly and rearwardly.

In an embodiment such as provided in FIGS. 2A to 2B, and 4A to 8D, the upper and lower linkage members 20, 30 are opposingly rotatably coupled to one another. In an example, the upper and lower linkage members 20, 30 are opposingly rotatably coupled to one another by a gearing arrangement that includes a first gear element 36 and a second gear element 26. The lower linkage member 30 includes the first gear element 36 and upper linkage member 20 includes the second gear element 26 that is meshed with the first gear element 36 for opposingly rotatably coupling the upper linkage member 20 and the lower linkage member 30.

In an additional embodiment such as provided in FIGS. 4A to 8D, the first gear element 36 is a first sector gear 36a that is formed on an end of the lower linkage member 30, and the second gear element 26 is a second sector gear 26a that is formed on the upper linkage member 20 (e.g., an upper linkage member gear member 22 of the upper linkage member 20).

In the specific embodiment provided in FIG. 4A to 8D, the first sector gear 36a is formed on the second end portion 30b of the lower linkage member 30, proximate the second lower mounting aperture 32 on the second end portion 30b of the lower linkage member 30. The first sector gear 36a is integrally formed with the second end portion 30b of the lower linkage member 30. The second sector gear 26a is formed on the first end portion of the upper linkage member 20, proximate the first upper mounting aperture 22a on the first end portion of the upper linkage member 20. The second sector gear 26a is integrally formed with the upper linkage member gear member 22 of the upper linkage member 20.

Referring to FIG. 5A, there is provided an embodiment of the upper linkage member 20 of the at least one movement linkage 12. The upper linkage member 20 includes the first end and the second ends 20a, 20b thereof, as well as the first upper mounting aperture 22a that is formed in the upper linkage member gear member 22. The upper linkage member 20 also includes a connection structure for connecting the first cross members 52 to the upper linkage member 20.

In the specific embodiment provided in FIG. 5A, the upper linkage member 20 includes the upper linkage member gear member 22, an upper frame tube 23 connected to the upper linkage member gear member 22, and a handle 27 that is connected to an end of upper frame tube 23 that is opposite the upper linkage member gear member 22. The second gear element 26 is integrally formed as part of the upper linkage member gear member 22, and the first upper mounting aperture 22a is formed through the upper linkage member gear member 22. Part of the upper linkage member gear element 22 is connected within a hollow interior of the upper frame tube 23, and a portion of the handle 27 is also connected within the hollow interior of the upper frame tube 23, by any suitable method such as one or more of a press fit, adhesive, welding or brazing, and one or more mechanical fasteners. The connection structure of the upper linkage member 20 includes a rectangular spacer 28 that is connected to upper frame tube 23 via a pair of socket head screws 29.

Various embodiments of the lower linkage member 30 are provided within the recline assembly of the present disclosure. FIGS. 2A to 2B, and 4A to 9B provide a first embodiment of lower linkage member 30 with an interior portion that includes an interior aperture 34, while FIGS. 10A to 10E show an alternative embodiment of the lower linkage member which is shown at 130 and which includes a bend formed along the length thereof, between first and second end portions 130a, 130b of the lower linkage member 130.

Referring to FIG. 5B, the first and second lower mounting apertures 31, 32 are formed proximate the respective first and second end portions 30a, 30b. The lower linkage member 30 also includes an interior aperture 34 that is positioned along an intermediate portion of the lower linkage member 30. The interior aperture 34 extends through the thickness of the lower linkage member 30.

Referring to FIGS. 10A, 10B, 10D, and 10E, there is provided a second embodiment of the lower linkage member 30 that is the lower linkage member 130. Like the lower linkage member 30, the lower linkage member 130 includes first and second end portions 130a, 130b, which are structurally similar to the first and second end portions 30a, 30b, as well as the first and second lower mounting apertures 31, 32 formed proximate the respective first and second end portions 130a, 130b. The length of the lower linkage member 130 includes a bend formed along the length thereof, where this bend is formed to provide clearance for the portion of the second cross member 154 that is held in the cross support aperture 118 of the mount body 18a. Referring to FIGS. 10D and 10E, as the lower linkage member 130 moves from the first rotational position to the second rotational position (for the lower linkage member 130), the intermediate linkage member 18 pivots rearwardly relative to the second end portion 130b of the lower linkage member 130, which drive the portion of the intermediate linkage member 18 that includes the portion of the second cross member 154 rearward. To prevent the second cross member 154 and/or the intermediate linkage member 18 from contacting the lower linkage member 130 during this rotation, a downward bend is formed in the lower linkage member 130 such that the portion of the second cross member 154 translates towards the inner corner of this bend as the lower linkage member 130 moves from the first rotational position towards the second rotational position for the lower linkage member 130

In at least some embodiments of the present disclosure, the pin connections as disclosed above, which provide the pivoting connection of various elements of the movement linkages 12, can include suitable pin, nut or machine screw, and any suitable arrangement or number of washers or spacers as is known in the art for providing pin connections between moving members. In some embodiments, the pin connections between the mounting plate 18, base 13, upper linkage member 20, lower linkage member 30, guide member 40 and/or actuator 60 are substantially the same structure of pin connection. In at least some other embodiments, the pin connections between the mounting plate 18, base 13, upper linkage member 20, lower linkage member 30, guide member 40 and/or actuator 60 include at least two different structures of pin connection.

As provided above, the at least one movement linkage 12 can include the plurality of cross members 50. In the specific embodiment provided in FIGS. 4A to 4C, 6, and 7A to 8D, the plurality of cross members 50 includes the first cross member 52 and the second cross member 54. The first cross member 52 is formed as a rectangular bar 52a. The rectangular spacer 28 on the upper linkage member 20 of each of the two movement linkages is connected to the rectangular bar 52a such that the rectangular bar 52a spans at least the space between the upper linkage members 20 of the two movement linkages 12. Opposing end of the rectangular bar 52a includes end caps 53. A pair of mounting brackets 64 are also connected on the rectangular bar 52a, where the pair of mounting brackets 64 correspond to the pair of movement linkages 12 and provide a structure for pivotably connecting an upper end of the actuator to the second end 20b of the upper linkage member 20 (via the first cross member 52). Each mounting bracket 64 of the pair of mounting brackets 64 includes a pair of L-brackets with pin mounted therethrough, the two mounting brackets 64 (one for each actuator 60) are provided on opposing lateral ends of the rectangular bar 52a and are connected to a bottom surface of the rectangular bar 52a.

The second cross member 54 includes a bottom connection shaft 54a. The ends of the bottom connection shaft 54a are securely received in the interior apertures 34 of the lower linkage members 30 of the pair of movement linkages 12. The rectangular bar 52a and the bottom connection shaft 54a of the plurality of cross members 50 provide a structure that movably couples the upper and lower linkage members 20, 30 of each of the pair of movement linkages 12 together, such that the pair of movement linkages 12 can move together.

As provided above, the at least one movement linkage 12 may include the actuator 60 that is that is operatively connected to at least one of the lower linkage member 30 and the upper linkage member 20 to drive pivoting of said at least one of the lower linkage member 30 and the upper linkage member 20.

In an embodiment, the actuator 60 is the linear actuator 60a, and the linear actuator 60a has a first end that is pivotally connected to the upper linkage member 20 and a second end that is pivotally connected to the lower linkage member 30.

In an additional embodiment where the actuator 60 is a linear actuator 60a, the linear actuator 60 is pivotably connected to the lower linkage member 30 and to an upper portion of the upper linkage member 20 (e.g., at the second pivot connection point of the upper linkage member). The linear actuator 60a is actuatable between an extended position (shown in FIGS. 2A, 7A, 8A, 8B, and 10A) and a retracted position (shown in FIGS. 2B, 7B, 8C, and 10B), where the actuation of the linear actuator 60a from the extended position to the retracted position drives the upper linkage member to move from the first rotational position to the second rotational position (for the upper linkage member) and also drives the lower linkage member to move from the first rotational position to the second rotational position (for the lower linkage member). The linear actuator 60a may be constructed such that an overall length of the linear actuator 60a is less in a retracted position than in an extended position.

In an additional embodiment, the linear actuator 60a is a hydraulic, linear actuator with a piston rod that slides within a piston housing for moving between the retracted and extended positions.

In an alternative embodiment, the linear actuator 60a is a single axis, screw-driven actuator that includes an actuator rod with a screw element, and an actuator housing within which the actuator rod is driven to move by the screw element.

In the specific embodiment provided in FIGS. 2A to 2B, 4A to 4C, and 6 to 8D, the actuator 60 of each movement linkage 12 of the pair of movement linkages 12a, 12b is the linear actuator 60a that includes an actuator housing 62 and an actuator rod 61. A free end 61a of the actuator rod 61 includes a connection aperture, and a bottom end of the actuator housing 62 includes a connection flange 63 with a connection aperture extending through the connection flange 63. The connection aperture on the free end 61a of the actuator rod 61 is pivotably received on the pin of one of the pair of mounting brackets 64 on the first cross support 52. As the first cross support 52 is connected between the upper linkage members 20, the linear actuator 60a is thereby connected to the upper linkage member 20 by way of the first cross support 52. The connection aperture in the connection flange 63 is received on the bottom connection shaft 54a of the plurality of cross members 50. As the bottom connection shaft 54a is mounted through the interior aperture 34 of the lower linkage member 30 on each movement linkage 12, the mounting of the connection flange 63 on the bottom connection shaft 54a effectively connects the actuator 60 and the lower linkage member 30. The connection of the linear actuator 60a between the upper and lower linkage members 20, 30, and the connection of the guide member 40 between the base 13 and mount body 18, constrain and there by guide the overall motion of the movable components of the movement linkage 12.

Various arrangements of actuators 60 may be provided as part of the reclining assembly 10 such that each movement linkage 12 does not have to have an associated actuator 60.

In at least some embodiments where the at least one movement linkage 12 is a pair of movement linkages 12, both movement linkages 12 include the actuator 60. In at least some other embodiments where the at least one movement linkage 12 is a pair of movement linkages 12, a single actuator 60 may be provided. In such embodiments, the single actuator 60 may be provided as part of one of the movement linkages 12, while the other movement linkage 12 that does not include the actuator 60 may include a slider linkage (not shown) in place of the actuator 60. Like the actuator 60, the slider linkage is connected between the upper portion of the upper linkage member 20 and the lower linkage member 30. In another embodiment, the single actuator 60 may optionally not be associated directly with either one of the two movement linkages 12, and may, for example, extend from a middle of the first cross member 52 or the first cross member 152 to a middle of the second cross member 54 or second cross member 154. The plurality of cross members 50 of the reclining assembly 10 couples the motion of the pair of movement linkages 12 together such that one movement linkage 12 actuates with the other movement linkage 12, and a single actuator 60 in only one of the movement linkages is capable of driving the motion of both movement linkages 12. During the motion of the movement linkage 12 that is driven by the single actuator 60, the slider linkage may extend and reduce in length corresponding to the extension and retraction of the single actuator 60 such that the pair of movement linkages 12 can move together.

As will be recognized, the recline assembly 10 of the present disclosure may be adaptable to a motorized wheelchair that includes at least one motor. The at least one motor can be operatively connected to the actuator 60 to drive the motion of the actuator 60 between the extended and retracted positions. Alternatively, a motor of the motorized wheelchair can be powered by on-board batteries, and the actuator 60 can be operatively connected to, and powered by, the on-board batteries that drive the motorized wheelchair. The recline assembly 10 can also be used on other types of wheelchairs, such as non-motorized wheelchairs. As long as a power supply such as an on-board battery is provided with the wheelchair for powering the motion of the actuator 60 of the at least one movement linkage 12, the recline assembly 10 can be readily adapted to other wheelchairs or chair structures. The recline assembly 10 may provide a compact mechanism that is easily secured to a wheelchair seat without using a complex linkage and actuator assembly.

The details of the operation of the recline assembly 10 will now be described with reference to FIGS. 2A to 2B, and FIGS. 7A to 8D. When the movement linkage 12 is in a non-reclined position (shown in FIGS. 2A, 7A, 8A, and 8B), the back support 6 is generally upright relative to the seat of the chair (see FIG. 1). In this non-reclined position, the lower linkage member 30 is in the first rotational position for the lower linkage member, and the guide member 40 is in a corresponding first rotational position for the guide member such that the mount body 18a is supported above the support bracket 14 of the base 13. The upper linkage member 20 is held in the first rotational position for the upper linkage member, with the second gear element 26 on the upper linkage member 20 meshed within the first gear element 36 on the lower linkage member 30, but not actively transmitting torque therebetween. The linear actuator 60a is in the extended position, connected between the upper portion of the upper linkage member 20 and the interior section of the lower linkage member 30 (via the lower cross support 54).

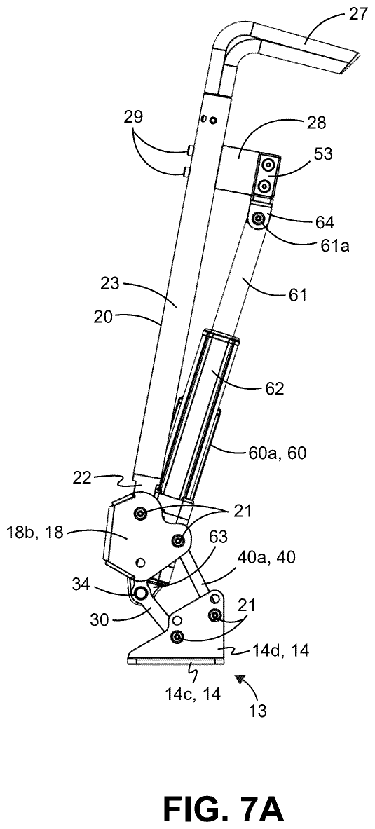

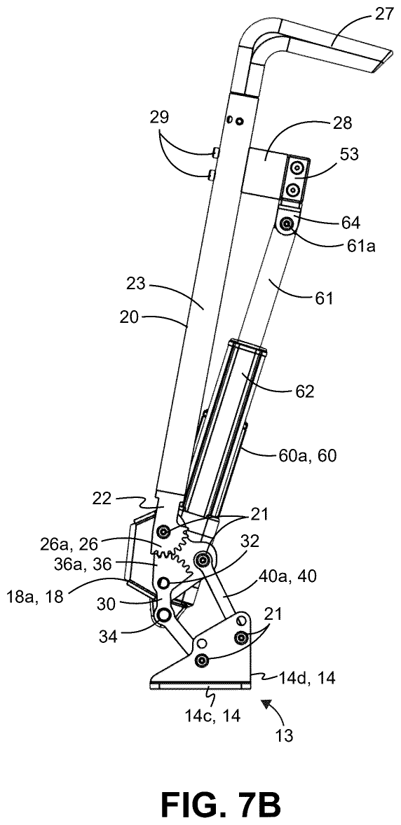

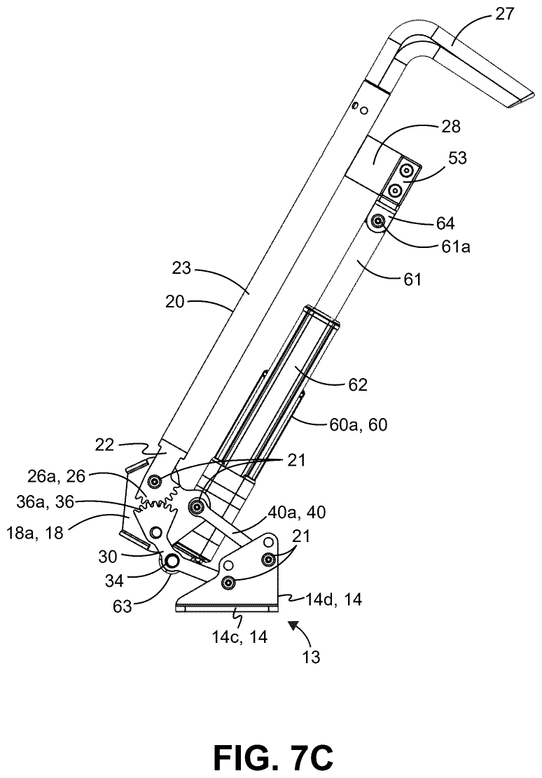

When operating the movement linkage 12 to move to a reclined position and thereby recline the back support 6, the linear actuator 60a is operated, and the actuator rod 61 of the linear actuator 60a is withdrawn further into the actuator housing 62 such that the linear actuator 60a moves towards the retracted position (shown in FIGS. 2B and 7B). Due to the withdrawal of the actuator rod 61, the overall length of the linear actuator 60a is shortened. This shortening of the overall length of the linear actuator 60a causes the actuator rod 61 to apply a downward force on the upper portion of the upper linkage member 20 (i.e., a force in the clockwise direction, as viewed in FIGS. 7A to 8D). The downward force applied by the actuator rod 61 on the upper portion of the upper linkage member 20 drives second pivot connection point of the upper linkage member to move rearwardly and downwardly, relative to the first pivot connection point of the upper linkage member. This pivoting is in the clockwise direction as viewed in FIGS. 7A to 8D. As the upper linkage member 20 begins to pivot from the first rotational position for the upper linkage member (shown in FIGS. 7A, 8A, and 8B) towards the second rotational position for the upper linkage member (shown in FIG. 7B, and 8C), the second gear element 26 on the upper linkage member 20 engages the first gear element 36 on the lower linkage member 30, driving the lower linkage member 30 to rotate from the first rotational position for the lower linkage member (shown in FIG. 7A) towards the second rotational position for the lower linkage member (shown in FIG. 8C), in the counterclockwise direction as viewed in FIGS. 7A to 8D. This movement of the lower linkage member drives the movement of the intermediate linkage member and guide member, which in turn drives the first pivot connection point of the upper linkage member forward, as the second pivot connection point of the upper linkage member 20 rotates rearwardly and downwardly. While the above-described operation of the recline assembly 10 is specific to FIGS. 2A to 2B, and 4A to 8D, it will be readily understood that similar principles of operation apply to the embodiment of the recline assembly 10 provided in FIGS. 10A to 10E.

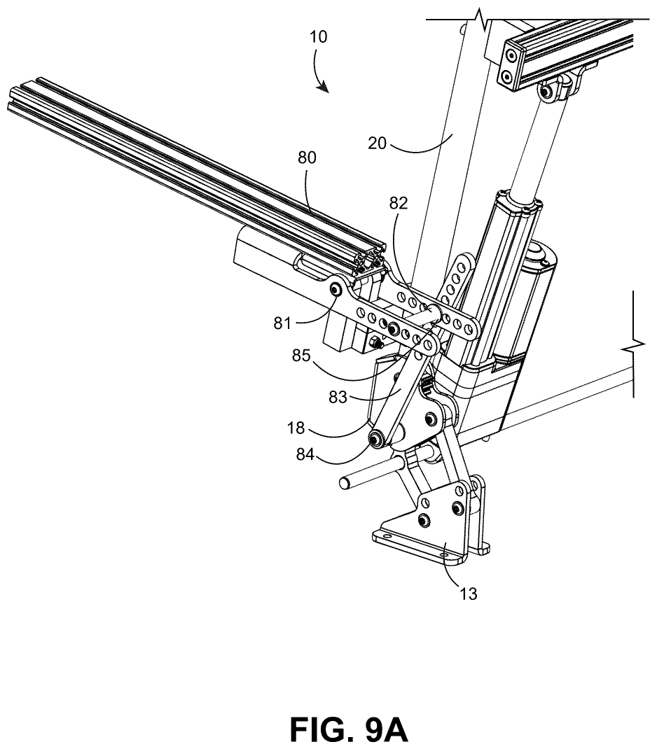

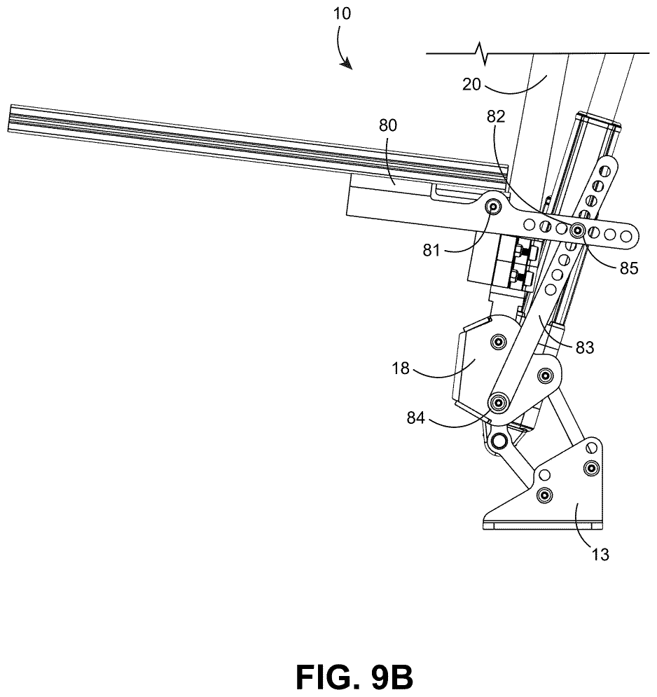

In an additional embodiment such as provided in FIGS. 9A, 9B, 10A, and 10B, the recline assembly 10 further comprises an armrest 80 and an armrest link 83. As shown in FIGS. 9A and 9B, the armrest 80 may have a longitudinal axis (L), and may include a first pivot connector 81 positioned to pivotally connect to the upper linkage member 20, and a second pivot connector 82 that is spaced axially from the first pivot connector 81. The armrest link 83 may have a first pivot connector 84 positioned to pivotally connect to the intermediate linkage member 18, and a second pivot connector 85 that is positioned to pivotally connect to the second pivot connector 82 of the armrest 80. The first and second pivot connectors 81, 82 of the armrest 80 and the first and second pivot connectors 84, 85 of the armrest link 83 are positioned such that during movement of the upper linkage member 20 through an upper linkage member angle between the first and second rotational positions for the upper linkage member, the armrest 80 is pivoted through an armrest angle that is smaller than the upper linkage member angle.

It has been found that embodiments of the present disclosure provide a recline assembly 10 for adjusting a backrest of a wheelchair. Further, unlike certain prior wheelchairs, the recline assembly 10 is less susceptible to binding and malfunctioning and is less complex than existing no-shear mechanisms.

While the recline assembly 10 described herein relates to a backrest and a seat for reducing shear on the back of the user, it will be understood that the recline assembly shown and described may be used in other applications, where the pivot point of the assembly when in a first position and the pivot point on the user when the assembly is in the first position, are spaced from one another. For example, applications may include a leg rest, an arm rest, or a head rest. Thus, more broadly worded, the recline assembly may be referred to as an angle adjustment assembly for a chair, the chair including a first body portion support member and a second body portion support member. In the examples shown herein the first body portion support member is a seat 8 and the second body portion support member is the back support 6. The angle adjustment assembly includes at least one movement linkage that includes the base 13, the lower linkage member 30, the intermediate linkage member 18, the upper linkage member 20, and the guide member 40, all of which may be modified in shape for the particular positional relationships applicable to the particular usage. For example, for a headrest application, the first body portion support member may be the back support of the chair and the second body portion support member may be a movable headrest. For a leg rest application the first body portion support member may be the back support of the chair and the second body portion support member may be a movable leg rest. The base includes a base connector that is positioned to be supported by a frame of the chair. The lower linkage member has a first pivot connection point that is pivotably connected to the base for rotation thereabout between a first rotational position for the lower linkage member and a second rotational position for the lower linkage member and a second pivot connection point that is pivotally connected to the intermediate linkage member, wherein the second pivot connection point of the lower linkage member is driven forwardly during pivoting of the lower linkage member towards the second rotational position for the lower linkage member. The guide member is connected between the base and the intermediate linkage member, and is structured to constrain the intermediate linkage member to move along a fixed path as the lower linkage member pivots between the first and second rotational positions for the lower linkage member. The upper linkage member includes an upper linkage member connector positioned for connecting to the second body portion support member, and includes a first pivot connection point and a second pivot connection point. The first pivot connection point is pivotably connected to the intermediate linkage member. The upper linkage member is pivotable relative to the intermediate linkage member between a first rotational position for the upper linkage member and a second rotational position for the upper linkage member. The second pivot connection point of the upper linkage member is driven rearwardly and downwardly/upwardly (e.g. for a back support or a headrest), or forwardly and upwardly/downwardly (e.g. for a leg rest, an armrest or a footrest) during pivoting of the upper linkage member towards the second rotational position for the upper linkage member, thereby driving the upper linkage member towards a horizontal orientation, wherein the lower linkage member is opposingly rotatably coupled to the upper linkage member such that pivoting of one of the lower linkage member and the upper linkage member towards the second rotational position for said one of the lower linkage member and the upper linkage member, drives pivoting of the other of the lower linkage member and the upper linkage member towards the second rotational position for said other of the lower linkage member and the upper linkage member, which drives the first pivot connection point of the upper linkage member forwardly or rearwardly to reduce shear on the body of the user, and drives the second pivot connection point of the upper linkage member downwardly and rearwardly. For the rearward and downward movement of the second pivot connection point of the upper linkage member, the first pivot connection point is driven forward. For the rearward and upward movement of the second pivot connection point of the upper linkage member, the first pivot connection point is driven rearward. For the forward and downward movement of the second pivot connection point of the upper linkage member, the first pivot connection point is driven rearward. For the forward and upward movement of the second pivot connection point of the upper linkage member, the first pivot connection point is driven forward.

For greater certainty, the term ‘chair’ is intended to be construed broadly, to include items such as office chairs, residential chairs, wheelchairs, sofas automobile seats, airline seats, or any other vehicular seat, or any other suitable body support device.

While various spatial and directional terms, such as top, bottom, lower, mid, lateral, horizontal, vertical, front and the like may have been used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

The specific embodiments described above have been shown by way of example, and it should be understood that these embodiments may be susceptible to various modifications and alternative forms. It should be further understood that the above-described embodiments are intended to be examples of the present disclosure and alterations and modifications may be effected thereto, by those of skill in the art, without departing from the scope of the disclosure that is defined solely by the claims appended hereto.

### REFERENCE NUMERALS

1 motorized wheelchair
2 front wheels
3 rear wheels
4 frame
6 back support
7 joystick assembly
8 seatt
10 recline assembly
12 movement linkage
13 base
14 support bracket
14a inner flange
14b outer flange
14c horizontal flange
14d vertical flange
14e mounting aperture
17 bent flange
18 intermediate linkage member
18a mount body
18b inner bracket
18c outer bracket
18e mount aperture
19 bushings
20 upper linkage member
20a first end portion of upper linkage member
20b second end portion of upper linkage member
21 pin connections
22 upper linkage member gear member
22a aperture in upper linkage member gear member
23 upper frame tube
26 second gear element
26a second sector gear
27 handle
28 rectangular spacer
29 socket head screws
30 lower linkage member
30a first end of lower linkage member
30b second end of lower linkage member
32 first lower mounting aperture
33 second lower mounting aperture
34 interior aperture
36 first gear element
36a first sector gear
40 guide member
40a first end of the guide member
40b second end of the guide member
41 first guide mounting aperture
42 second guide mounting
50 mounting frame
52 first cross support
52a rectangular bar
53 end cap
54 second cross support
54a shaft
60 actuator
61 actuator rod
61a free end of piston rod
62 actuator housing
63 connection flange
64 mounting brackets
80 armrest
81 first pivot connector for armrest
82 second pivot connector for armrest
83 armrest link
84 first pivot connector for armrest linkage
85 second pivot connector for armrest linkage
118 cross support aperture
130 lower linkage member
130a first end portion of the lower linkage member
130b second end portion of the lower linkage member
150 plurality of cross members
152 first cross support
154 second cross support

What is claimed is:

1. A recline assembly for a chair with a seat and a movable back support, the recline assembly comprising:
at least one movement linkage that includes:
a base that includes a base connector that is positioned to be supported by a frame of the chair;
an intermediate linkage member;
a lower linkage member having a first pivot connection point that is pivotably connected to the base for rotation thereabout between a first rotational position for the lower linkage member and a second rotational position for the lower linkage member and a second pivot connection point that is pivotally connected to the intermediate linkage member, wherein the second pivot connection point of the lower linkage member is driven forwardly during pivoting of the lower linkage member towards the second rotational position for the lower linkage member;
a guide member that is connected between base and the intermediate linkage member, wherein the guide member is structured to constrain the intermediate linkage member to move along a fixed path as the lower linkage member pivots between the first and second rotational positions for the lower linkage member; and
an upper linkage member that includes an upper linkage member connector positioned for connecting to the back support, wherein the upper linkage member includes a first pivot connection point and a second pivot connection point, wherein the first pivot connection point is pivotably connected to the intermediate linkage member, wherein the upper linkage member is pivotable relative to the intermediate linkage member between a first rotational position for the upper linkage member and a second rotational position for the upper linkage member, wherein the second pivot connection point of the upper linkage member is driven rearwardly and downwardly during pivoting of the upper linkage member towards the second rotational position for the upper linkage member, thereby driving the upper linkage member towards a horizontal orientation, wherein the lower linkage member is opposingly rotatably coupled to the upper linkage member such that pivoting of one of the lower linkage member and the upper linkage member towards the second rotational position for said one of the lower linkage member and the upper linkage member, drives pivoting of the other of the lower linkage member and the upper linkage member towards the second rotational position for said other of the lower linkage member and the upper linkage member, which drives the first pivot connection point of the upper linkage member forwardly, and drives the second pivot connection point of the upper linkage member downwardly and rearwardly.

2. The recline assembly of claim 1, wherein the guide member is a guide linkage that is pivotably connected between the intermediate linkage member and the base to form a four-bar mechanism that includes the base, the intermediate linkage member, the lower linkage member and the guide linkage.

3. The recline assembly of claim 1, where the at least one movement linkage includes a first movement linkage and a second movement linkage.

4. The recline assembly of claim 3, further comprising with a first cross member that extends laterally and is connected between the upper linkage member of the first movement linkage and the upper linkage member of the second movement linkage, and a second cross member that is connected between the lower linkage member of the first movement linkage and the lower linkage member of the second movement linkage.

5. The recline assembly of claim 4, wherein the second cross member is pivotally mounted to an intermediate portion of the lower linkage member of each of the first and second movement linkages.

6. The recline assembly of claim 4, wherein the back support of the chair is directly connected to the first cross member.

7. The recline assembly of claim 1, wherein the lower linkage member has a first gear element, and wherein the upper linkage member has a second gear element that is meshed with the first gear element for opposingly rotatably coupling the upper linkage member and the lower linkage member.

8. The recline assembly of claim 7, wherein the first gear element is a first sector gear that is formed on the lower linkage member, and wherein the second gear element is a second sector gear that is formed on the upper linkage member.

9. The recline assembly of claim 7, further comprising an actuator that is operatively connected to at least one of the lower linkage member and the upper linkage member to drive pivoting of said at least one of the lower linkage member and the upper linkage member towards the second rotational position for said at least one of the lower linkage member and the upper linkage member.

10. The recline assembly of claim 1, wherein the actuator is a linear actuator.

11. The recline assembly of claim 10, wherein the linear actuator has a first end that is pivotally connected to the upper linkage member and a second end that is pivotally connected to the lower linkage member.

12. The recline assembly of claim 11, further comprising an armrest and an armrest link, wherein the armrest has a longitudinal axis, and has a first pivot connector positioned to pivotally connect to the upper linkage member, and a second pivot connector that is spaced axially from the first pivot connector, wherein the armrest link has a first pivot connector positioned to pivotally connect to the intermediate linkage member, and a second pivot connector that is positioned to pivotally connect to the second pivot connector of the armrest, wherein the first and second pivot connectors of the armrest and the first and second pivot connectors of the armrest link are positioned such that during movement of the upper linkage member through an upper linkage member angle between the first and second rotational positions for the upper linkage member, the armrest is pivoted through an armrest angle that is smaller than the upper linkage member angle.

13. The recline assembly of claim 1, wherein the first pivot connection point of the lower linkage member is formed on a first end portion of the lower linkage member, and the second pivot connection point of the lower linkage member is formed on a second end portion of the lower linkage member that is opposite the first end portion; and
wherein the first pivot connection point of the upper linkage member is formed on a first end portion of the upper linkage member, and the second pivot connection point of the upper linkage member is formed on a second end portion of the upper linkage member that is opposite the first end portion.
